(19) United States
(12) Patent Application Publication
(10) Pub. No.: US 2021/0331252 A1
(43) Pub. Date: Oct. 28, 2021

(54) SELECTIVELY MELT MICRON-SIZED PARTICLES USING MICRO-MIRRORS

(71) Applicant: HEWLETT-PACKARD DEVELOPMENT COMPANY, L.P., Spring, TX (US)

(72) Inventors: Seongsik Chang, Palo Alto, CA (US); Krzysztof Nauka, Palo Alto, CA (US); Alejandro Manuel De Pena, Sant Cugat del Valles (ES); Lihua Zhao, Palo Alto, CA (US)

(21) Appl. No.: 16/606,084

(22) PCT Filed: Jul. 31, 2018
(86) PCT No.: PCT/US18/44653

§ 371 Date: Oct. 17, 2019

(51) Int. Cl. B22F 12/43; B22F 10/28; B22F 10/36; B28B 1/00; B28B 17/00; B33Y 10/00; B33Y 30/00; B33Y 50/02; B23K 26/06

(52) U.S. Cl. CPC B22F 12/43; B22F 10/28; B22F 10/36; B28B 1/001; B23K 26/0643; B33Y 10/00; B33Y 30/00; B33Y 50/02; B28B 17/0081

(57) ABSTRACT

According to examples, an apparatus may include an array of micro-mirrors, each of the micro-mirrors being individually controllable to selectively be in a first position or a second position, and a light source to direct a pulse of light onto the array of micro-mirrors with sufficient intensity to cause micron-sized particles on a powder bed upon which the light is directed from the array of micro-mirrors to at least partially melt. Each of the micro-mirrors that is in the first position may reflect light onto a respective area on a layer of micron-sized particles to at least partially melt the micron-sized particles in the respective area and each of the micro-mirrors that is in the second position may reflect light away from the powder bed on which the micron-sized particles are supported.

### BACKGROUND

In three-dimensional (3D) printing, an additive printing process is often used to make three-dimensional solid parts from a digital model. Some 3D printing techniques are considered additive processes because they involve the application of successive layers or volumes of a build material, such as a powder or powder-like build material, to an existing surface (or previous layer). 3D printing may include solidification of the build material, which for some materials may be accomplished through use of heat and/or a chemical binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus to selectively melt micron-sized particles in a powder bed using micro-mirrors;

FIG. 2 shows a block diagram of an example micro-mirror that may be employed in the example apparatus depicted in FIG. 1;

FIG. 3 shows a block diagram of another example apparatus to selectively melt micron-sized particles in a powder bed using micro-mirrors; and

FIG. 4 shows a flow diagram of an example method to at least partially melt micron-sized particles in selected areas of a powder bed.

### DETAILED DESCRIPTION

3D printing technologies that employ build material powder, e.g., metal powder, to print 3D objects may include a laser beam source. In these types of 3D printing technologies, the laser beam source may be controlled to selectively direct a laser beam onto areas of the build material powder that are to fuse together. That is, the build material powder may be applied into successive layers and a laser beam may be scanned across the respective layers to selectively melt the powder in the areas of the layers that are to be formed into a 3D object. Sections of the 3D object may thus be formed one layer at a time through the selective fusing of the powder in the layers. As the laser beam may be relatively focused to relatively small areas of the powder during a fusing operation, a relatively long period of time may be taken in the formation of the sections of the 3D object in each of the layers. As a result, the printing of the 3D object may take a relatively long period of time.

Disclosed herein are apparatuses and methods that may be implemented to fabricate a 3D object from micron-sized particles using a light source and an array of micro-mirrors, which may decrease the length of time taken to fabricate the 3D object as compared with 3D printing techniques that employ a scanning laser beam. In the apparatuses and methods disclosed herein, the light source may direct a pulse, e.g., a flash, of light onto the array of micro-mirrors with sufficient intensity to cause micron-sized particles on which a pulse of light from the light source is directed from the array of micro-mirrors to at least partially melt. In addition, each of a plurality of areas on a surface of the powder bed may correspond to a particular micro-mirror and each of the micro-mirrors in the array may selectively be movable between a first position and a second position. The micro-mirrors that are in the first position may reflect light from the light source onto respective areas on the powder bed and micro-mirrors that are in the second position may direct light from the light source away from the powder bed.

In operation, a controller may determine the areas on the surface of the powder bed that are to be fused together, e.g., the areas of the powder bed that are to be fused together to form a section of a 3D fabricated object. The controller may also identify the micro-mirrors that correspond to the determined areas. The controller may further cause those micro-mirrors to be in the first position, e.g., an active position, while the micro-mirrors that correspond to areas other than the determined areas may be in the second position, e.g., an inactive position. In causing the micro-mirrors to be in the first position or the second position, the controller may maintain the micro-mirrors in the first position or the second position in instances in which the micro-mirrors are already in their intended positions. In addition, the controller may cause the light source to be activated to pulse a light beam for a short duration of time, e.g., about 10 milliseconds (msec) or less, such that the micro-mirrors that are in the first position reflect light onto corresponding areas of the powder bed.

The light source may output the light at a sufficient intensity level and for a sufficient duration of time that causes the intensity of the light at the powder bed to have sufficient energy to at least partially melt the micron-sized particles in the powder bed. For instance, the light source may be a Xenon light source, a fiber laser, or the like, and may output light at an intensity of at least 10 kW/cm² and total fluence of 30 J/cm² at the powder bed. While in the at least partially melted state, the micron-sized particles may flow together and may fuse together when cooled and solidified. In one regard, a section of a 3D fabricated object may be fabricated from the micron-sized particles in a relatively quick manner. That is, areas in a large portion of the powder bed, or the entire powder bed, may be illuminated with a single pulse of light from the light source such that the areas may be melted concurrently, which may be faster than scanning a heating lamp or a laser across the powder bed. Through implementation of the apparatuses and methods disclosed herein, therefore, 3D objects may be fabricated using micron-sized particles in a relatively shorter period of time than through fabrication using a scanning laser or heating lamp.

Before continuing, it is noted that as used herein, the terms “includes” and “including” mean, but is not limited to, “includes” or “including” and “includes at least” or “including at least.” The term “based on” means “based on” and “based at least in part on.”

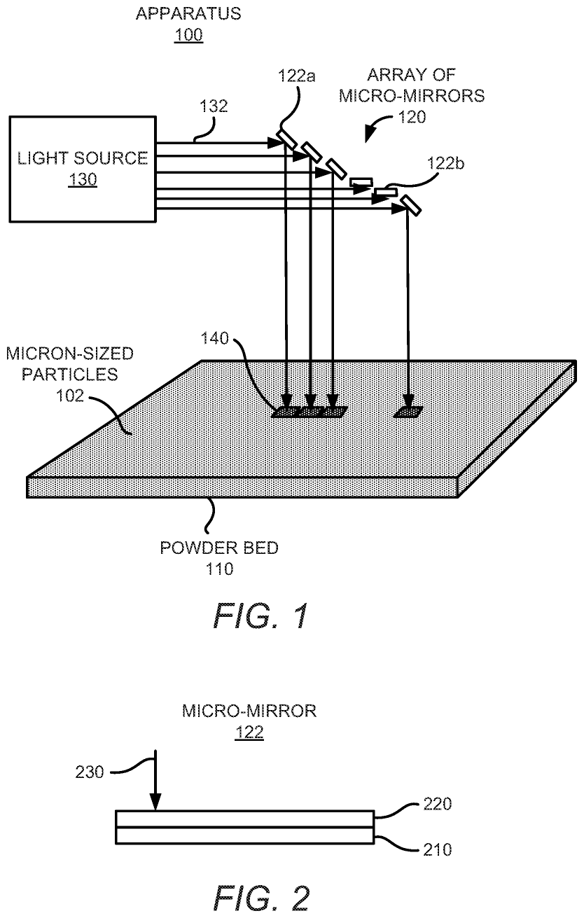

Reference is first made to FIG. 1, shows a block diagram of an example apparatus 100 to selectively melt micron-sized particles in a powder bed using micro-mirrors. It should be understood that the example apparatus 100 depicted in FIG. 1 may include additional features and that some of the features described herein may be removed and/or modified without departing from the scope of the apparatus 100.

Generally speaking, the apparatus 100 may be a 3D fabricating system, a 3D printer, a 3D fabricator, or the like. In any regard, the apparatus 100 may be implemented to fabricate 3D objects from selective fusing of micron-sized particles 102. The particles 102 may range in size from about 1 micron and about 100 microns or any particle size therebetween. For instance, the particles 102 may be formed to have dimensions, e.g., widths, diameters, or the like, that are generally between about 5 microns and about 100 microns. In other examples, the particles 102 may have dimensions that are generally between about 30 microns and about 60 microns. The particles 102 may have any of multiple shapes, for instance, as a result of larger particles being ground into smaller particles. In some examples, the particles 102 may be formed from, or may include, short fibers that may, for example, have been cut into short lengths from long strands or threads of material.

As shown in FIG. 1, the micron-sized particles 102 may be included in a powder bed 110 such that the micron-sized particles 102 at various locations in the powder bed 110 may selectively be melted and solidified. The micron-sized particles 102 may be a material that may be applied in layers and selectively solidified. For instance, the micron-sized particles 102 may be any material suitable for melting and selective solidification, including, but not limited to, a polymer, a plastic, a ceramic, a nylon, a metal, combinations thereof, or the like, and may be in the form of a powder or a powder-like material.

The apparatus 100 may include an array of micro-mirrors 120 that may individually be controllable to selectively be in a first position or a second position. The array of micro-mirrors 120 may be part of a digital micromirror device and the micro-mirrors 120 may be microelectromechanical systems (MEMS). That is, the positions, e.g., states, of the micro-mirrors 120 may be controlled through application of a voltage between electrodes around the micro-mirrors 120. The micro-mirrors 120 may also have dimensions such that the micro-mirrors 120 may not individually be viewable without a microscope. For instance, each of the micro-mirrors 120 may have micron-scale sizes, e.g., between around 10 and around 20 microns.

For purposes of illustration, a first micro-mirror 122a is depicted as being in the first position and a second micro-mirror 122b is depicted as being in the second position. Although not explicitly shown, the array of micro-mirrors 120 may include a three-dimensional array and may include a larger number of micro-mirrors 122 than is shown in FIG. 1. For instance, the array of micro-mirrors 120 may include a sufficient number of micro-mirrors 122 that are positioned to direct light beams across a substantial portion of the powder bed 110 or across an entire upper surface of the powder bed 110. In addition, each of the micro-mirrors 120 may be sized to direct light at a respective location on the powder bed 110 such that light reflected from the micro-mirrors 122 may be targeted across the powder bed 110.

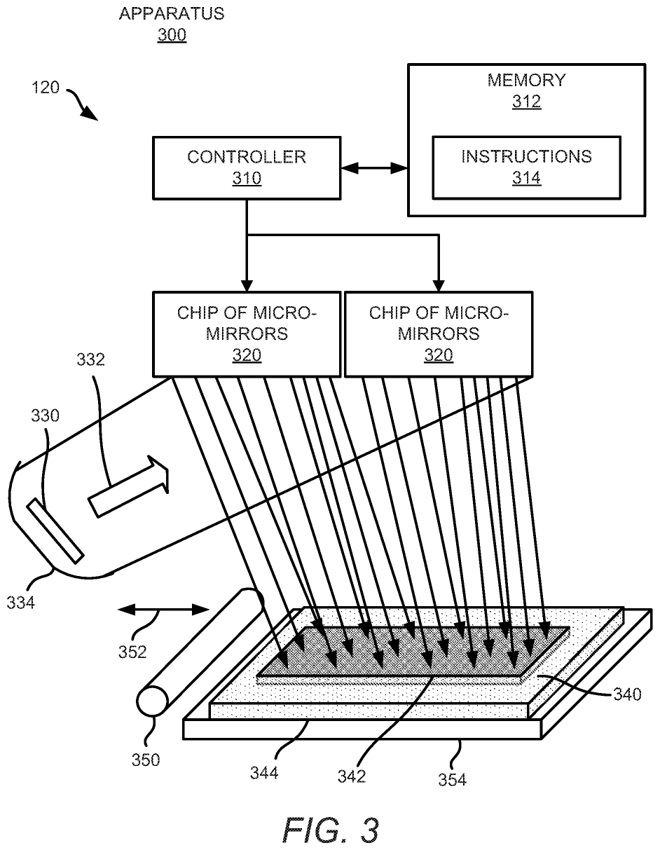

According to examples, the array of micro-mirrors 120 may be contained on a chip or on multiple chips, in which each of the chips may be a digital light processing chip, digital micro-mirror device chip, or the like. In any regard, each of the micro-mirrors 122 may separately be driven to the first position or the second position by respective motors (not shown). In addition, a controller 302 (FIG. 3) may track and individually control the respective motors to individually control the micro-mirrors 122 to be in one of the first position or the second position.

The micro-mirrors 122 may each be formed from any of a variety of materials, including, for example, aluminum. An example of a particular example micro-mirror 122 is depicted in FIG. 2. As shown in FIG. 2, the micro-mirror 122 may include an aluminum layer 210 with a protective silicon dioxide layer 220 on the aluminum layer 210. That is, the protective silicon dioxide layer 220 may be provided on a surface of the aluminum layer 210 upon which light as denoted by the arrow 230 is to be reflected. The silicon dioxide layer 220 may protect the aluminum layer from heat, from the micron-sized particles 102, etc.

With reference back to FIG. 1, the apparatus 100 may also include a light source 130 that may direct a pulse of light 132 onto the array of micro-mirrors 120 that the micro-mirrors 122 may reflect onto selected locations 140 on the powder bed 110 with a sufficient intensity level to cause the micron-sized particles 102 on which the light 132 is directed to at least partially melt. That is, the micro-mirrors 122a that are in the first position may reflect the light 132 onto the powder bed 110 while the micro-mirrors 122b that are in the second position may not reflect the light 132 onto the powder bed 110. Particularly, each location on the powder bed 110 may correspond to a respective micro-mirror 122 such that each of the locations 140 on the powder bed 110 may receive the light 132 by controlling the respective settings of the micro-mirrors 122 into one of the first position or the second position.

The light source 130, when activated, may output a pulse of light 132 to have sufficient intensity to cause the micron-sized particles 102 upon which the light 132 is directed by the array of micro-mirrors 120 to at least partially melt. According to examples, the light source 130 may be a Xenon (Xe) light source system, a fiber laser, a vertical-cavity surface-emitting laser (VCSEL), or the like. In addition or in other examples, the light source 130 may output a pulse of light at an intensity of at least 10 kW/cm² and total fluence of 30 J/cm² at the powder bed 110. That is, the light source 130 may output a pulse of light at a sufficient intensity that causes the intensity of the light at the powder bed 110 to be at least 10 kW/cm² and 30 J/cm². The type of light source 130 employed in the apparatus 100 may be based on the type of micron-sized particles 102, e.g., whether the micron-sized particles 102 are metal or ceramic.

Turning now to FIG. 3, there is shown a diagram of another example apparatus 300, such as a 3D fabrication system, that may selectively melt micron-sized particles 302 in a powder bed 304. It should be understood that the example apparatus 300 depicted in FIG. 3 and may include additional features and that some of the features described herein may be removed and/or modified without departing from the scope of the apparatus 300.

As shown in FIG. 3, the apparatus 300 may include a controller 310 that that may control operations of the apparatus 300. The controller 310 may be a semiconductor-based microprocessor, a central processing unit (CPU), an application specific integrated circuit (ASIC), a field-programmable gate array (FPGA), and/or other suitable hardware device. The apparatus 300 may also include a chip of micro-mirrors 320 (or multiple chips of micro-mirrors 320) that the controller 310 may control in the fabrication of 3D objects. Each of the chips of micro-mirrors 320 may be a digital micromirror device chip. The controller 310 may also control a light source 330, which may be equivalent to the light source 130 discussed above with respect to FIG. 1. Particularly, and as discussed in greater detail herein, the controller 110 may control the chip(s) of micro-mirrors 320 and the light source 320 to selectively melt micron-sized build material particles 340 located in a predefined first area 342 of a powder bed 344, which may also be termed as a layer 344 of micron-sized particles 340.

The apparatus 300 may also include a memory 312 that may have stored thereon machine readable instructions 314 (which may also be termed computer readable instructions) that the controller 310 may execute. Although the instructions 314 are discussed herein a single set of instructions, it should be understood that the instructions 314 may include multiple sets of instructions without departing from a scope of the apparatus 300.

The memory 312 may be an electronic, magnetic, optical, or other physical storage device that contains or stores executable instructions. The memory 312 may be, for example, Random Access memory (RAM), an Electrically Erasable Programmable Read-Only Memory (EEPROM), a storage device, an optical disc, and the like. The memory 312, which may also be referred to as a computer readable storage medium, may be a non-transitory machine-readable storage medium, where the term “non-transitory” does not encompass transitory propagating signals.

In other examples, instead of the memory 312, the apparatus 300 may include hardware logic blocks that may perform functions similar to the instructions 314. In yet other examples, the apparatus 300 may include a combination of instructions and hardware logic blocks to implement or execute functions corresponding to the instructions 314. In any of these examples, the controller 310 may implement the hardware logic blocks and/or execute the instructions 314.

The controller 310 may fetch, decode, and execute the instructions 314 to control formation of sections of a 3D object in respective layers 344 of the micron-sized particles 340 to form the 3D object. For instance, the apparatus 300 may include a spreader 350 that the controller 310 may control to spread a layer 344 of the micron-sized particles 340 on a build platform 354, which may be in a build chamber within which 3D objects may be fabricated from the micron-sized particles 340 provided in respective layers 344 on the build platform 354. Particularly, the build platform 354 may be provided in a build chamber of the apparatus 300 and may be moved downward as features of a 3D object are formed in successive layers 344 of the micron-sized particles 340. Although not shown, the micron-sized particles 340 may be supplied between the spreader 350 and the build platform 354 and the spreader 350 may be moved in a direction represented by the arrow 352 across the build platform 354 to spread the micron-sized particles 340 into a layer 344.

For a spread layer 344, the controller 310 may determine areas 342 of the micron-sized particles 340 on the layer 344 that are to be fused together. That is, the controller 310 may execute the instructions 314 to determine areas 342 on the layer 344 that are to be illuminated by respective micro-mirrors 122 of the chip(s) of micro-mirrors 320. As discussed herein, the micro-mirrors 122 may illuminate a large portion of or the entire surface of the layer 344 facing the chip(s) of micro-mirrors 320. In addition, each of the micro-mirrors 122 may be movable between an active position (e.g., first position) and an inactive position (e.g., second position). While in the active position, a micro-mirror 122 may direct light (as denoted by the arrow 332) from the light source 330 to a corresponding location on the layer 344 of micron-sized particles 340. However, while in the inactive position, the micro-mirror 122 may not direct light 332 from the light source 330 to a corresponding location on the layer 344 of micron-sized particles 340. Instead, the micro-mirror 122, in the inactive position, may direct the light 332 to a light sink (not shown) or to another location away from the layer 344.

The controller 310 may execute the instructions 314 to determine the areas 342 that are to be illuminated from, for instance, a data file of the 3D object to be fabricated. That is, the controller 310 may determine the areas 342 to correspond to the sections of the 3D object that are to be fused together to form part of the 3D object. In addition, the controller 310 may execute the instructions 314 to determine, based on the determined areas 342 that are to be illuminated, which of the micro-mirrors 122 is to be set to the active position and which of the micro-mirrors 122 is to be set to the inactive position. The controller 310 may also execute the instructions 314 to set each of the micro-mirrors 122 that are to illuminate the determined areas 342 to the active position and to set each of the micro-mirrors 122 that are not to illuminate the determined areas to the inactive position. The controller 310 may set the micro-mirrors 122 by maintaining the micro-mirrors 122 that are already in the determined active or inactive position.

The controller 310 may further execute the instructions 314 to activate the light source 330. The controller 310 may cause the light source 330 to output light 332 at a sufficient intensity and for a sufficient duration of time to cause the micron-sized particles 340 on which the light 332 is directed to at least partially melt. By way of example, the controller 310 may cause the light source 330 to be activated for about 10 msec or less and the light source 330 may output light 332 at an intensity that may result in the intensity of the light 332 at the layer 344 to be between at least 10 kW/cm² and total fluence of 30 J/cm². In any regard, the micron-sized particles 340 in the determined areas may at least be partially melted through application of the pulse of light from the light source 330.

Following the application of the light 332 and the at least partial melting, the melted micron-sized particles 340 may flow together and become fused when cooled and hardened. A section of the 3D object may thus be formed in the layer 344 from the areas 342 that received the illumination from the light source 330. The controller 310 may repeat this process to form additional sections of the 3D object in subsequent layers 344 of the micron-sized particles 340. In one regard, the micron-sized particles 340 in each of the layers 344 may at least be partially melted concurrently with each other and thus, the sections of the 3D object may be formed in a relatively quicker manner than through use of a heating element that is scanned across the layer 344.

As also shown in FIG. 3, a light source reflector 334 may be positioned to direct the light 332 from the light source 330 toward the chip(s) of micro-mirrors 320. The reflector 334 may be formed of any suitable material that sufficiently reflects the light from the light source 333 toward the chip(s) of micro-mirrors 320. For instance, the reflector 334 may be formed of aluminum. In addition, the reflector 334 may include a protective silicon dioxide coating.

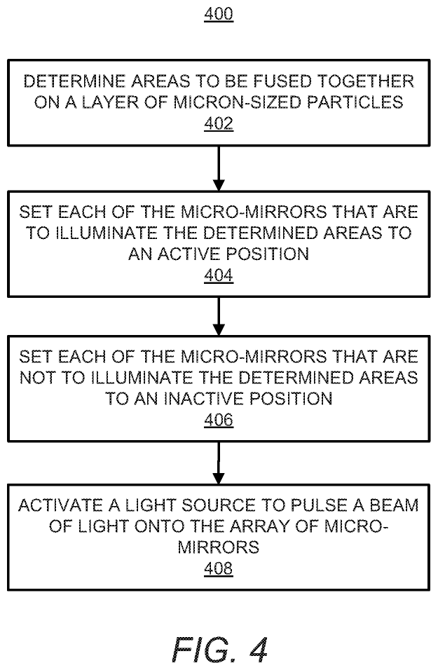

Various manners in which the controller 310 may operate are discussed in greater detail with respect to the method 400 depicted in FIG. 4. Particularly, FIG. 4 depicts a flow diagram of an example method 400 to at least partially melt micron-sized particles 340 in selected areas 342 of a powder bed 344. It should be understood that the method 400 depicted in FIG. 4 may include additional operations and that some of the operations described therein may be removed and/or modified without departing from scope of the method 400. The description of the method 400 is made with reference to the features depicted in FIGS. 1 and 3 for purposes of illustration.

At block 402, the controller 310 may determine selected areas 342 of a layer 344 of micron-sized particles 340 that are to be fused together. For instance, the controller 310 may access a file of a 3D object to be fabricated, in which the file may include data identifying predefined areas 342 of the layer 344 that are to be formed into a section of the 3D object. As noted above, each of the selected areas 342 may be illuminated by a respective micro-mirror 122 or a respective set of micro-mirrors 122 in an array of micro-mirrors 122. The array of micro-mirrors 122 may be housed in a single chip 320 or on multiple chips 320.

At block 404, the controller 310 set each of the micro-mirrors 122 that are to illuminate the determined selected areas 342 to an active position. In addition, at block 406, the controller 310 may set each of the micro-mirrors 122 that are not to illuminate the determined selected areas 342 to an inactive position. Blocks 404 and 406 may include the controller 310 causing some of the micro-mirrors 122 to be moved while not causing some of the micro-mirrors 122 to be moved. The controller 310 may not cause some of the micro-mirrors 122 to be moved when the micro-mirrors 122 are already in their intended positions. In this regard, the controller 310 may set the micro-mirrors 122 to the active or inactive positions by maintaining some of the micro-mirrors 122 in their current positions.

At block 408, the controller 310 may activate the light source 330 to pulse a beam of light 332 onto the array of micro-mirrors 122. The controller 310 may cause the light source 330 to output light 332 at a sufficient intensity and for a sufficient duration of time to cause the micron-sized particles 340 on which the light 332 is directed to at least partially melt. By way of example, the controller 310 may cause the light source 330 to be activated for about 10 msec or less and the light source 330 may output light 332 at an intensity that may result in the intensity of the light 332 at the layer 344 to be between at least 10 kW/cm² and total fluence of 30 J/cm². Following the application of the light 332 and the at least partial melting, the melted micron-sized particles 340 may flow together and become fused when cooled and hardened. A section of the 3D object may thus be formed in the layer 344 from the areas 342 that received the illumination from the light source 330. The controller 310 may repeat the method 400 to form additional sections of the 3D object in subsequent layers 344 of the micron-sized particles 340 until the 3D object is fabricated.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
an array of micro-mirrors, each of the micro-mirrors being individually controllable to selectively be in a first position or a second position; and
a light source to direct a pulse of light onto the array of micro-mirrors with sufficient intensity to cause micron-sized particles on a powder bed upon which the light is directed from the array of micro-mirrors to at least partially melt, wherein each of the micro-mirrors that is in the first position reflects light onto a respective area on a layer of micron-sized particles to at least partially melt the micron-sized particles in the respective area and each of the micro-mirrors that is in the second position reflects light away from the powder bed on which the micron-sized particles are supported.

2. The apparatus of claim 1, further comprising:
a controller to control each of the micro-mirrors to be in one of the first position and the second position.

3. The apparatus of claim 1, wherein the light source comprises one of a Xenon (Xe) flash lamp system and a fiber laser.

4. The apparatus of claim 3, wherein the Xe flash lamp system includes a Xe flash lamp and a reflector, the reflector having a silicon dioxide coating

5. The apparatus of claim 1, wherein the light source outputs a pulse of light at a peak intensity of at least 10 kW/cm² and total fluence of 30 J/cm² at the powder bed.

6. The apparatus of claim 1, wherein each of the micro-mirrors includes an aluminum layer and a protective silicon dioxide layer on the aluminum layer.

7. The apparatus of claim 1, further comprising:
a plurality of chips, each of the chips containing a respective array of micro-mirrors that are to selectively be in the first position or the second position, and each of the chips to direct light from the light source to respective sections of the layer of micron-sized particles.

8. A three-dimensional (3D) printing system comprising:
a spreader to spread a layer of powder on a printing platform, the powder having micron-sized particles;
a chip containing an array of movable micro-mirrors;
a controller to control each of the movable micro-mirrors to be in one of a first position or a second position; and
a light source to direct a pulse of light onto the array of micro-mirrors, wherein each of the micro-mirrors that is in the first position reflects light onto a respective area on the layer of micron-sized particles with sufficient intensity to at least partially melt the micron-sized particles in the respective area and each of the micro-mirrors that is in the second position reflects light away from the layer of powder.

9. The 3D printing system of claim 8, wherein the light source comprises one of a Xenon (Xe) flash lamp system and a fiber laser, the 3D printing system also including a reflector having a silicon dioxide coating.

10. The 3D printing system of claim 8, wherein the micron-sized particles include ceramic or metallic material and wherein the light source outputs light at an intensity of at least 10 kW/cm² and total fluence of 30 J/cm² at the powder bed.

11. The 3D printing system of claim 8, wherein each of the micro-mirrors includes an aluminum layer and a protective silicon dioxide layer on the aluminum layer.

12. The 3D printing system of claim 8, wherein the controller is to selectively control the movable micro-mirrors to be in one of the first position or the second position to selectively fuse the micron-sized particles in selected areas of the layer of powder.

13. A method comprising:
determining areas to be fused together on a layer of micron-sized particles, wherein each of the areas is to be illuminated by a respective micro-mirror in an array of micro-mirrors;
setting each of the micro-mirrors that are to illuminate the determined areas to an active position;
setting each of the micro-mirrors that are not to illuminate the determined areas to an inactive position; and
activating a light source to pulse a beam of light onto the array of micro-mirrors, wherein the micro-mirrors that are set to the active position direct the light to the determined areas with sufficient intensity to at least partially melt the micron-sized particles onto which the light is directed.

14. The method according to claim 13, wherein activating the light source further comprises activating the light source to pulse the light beam at an intensity of at least 10 kW/cm² and total fluence of 30 J/cm² at the powder bed and for around 10 milliseconds or less.

15. The method according to claim 13, wherein a set of the micro-mirrors that are to illuminate the determined areas are in the active position prior to the setting of the micro-mirrors to the active position and a set of the micro-mirrors that are not to illuminate the determined areas to the inactive position are in the inactive position prior to the setting of the micro-mirrors to the inactive position, and wherein setting each of the micro-mirrors that are to illuminate the determined areas to the active position further includes maintaining the set of the micro-mirrors that are in the active position in the active position and setting each of the micro-mirrors that are not to illuminate the determined areas to the inactive position further includes maintaining the set of the micro-mirrors that are in the inactive position in the inactive position.
